(19) United States
(12) Patent Application Publication
(10) Pub. No.: US 2019/0055000 A1
(43) Pub. Date: Feb. 21, 2019

(54) AIRCRAFT WING CONSTRUCTION ASSEMBLY WITH INTEGRATED IN SPAR RIB AND RIB POST

(71) Applicant: The Boeing Company, Chicago, IL (US)

(72) Inventors: Mohammad Barakatain, Mukilteo, WA (US); Mustapha Rahmani, Seattle, WA (US)

(73) Assignee: The Boeing Company, Chicago, IL (US)

(21) Appl. No.: 15/677,242

(22) Filed: Aug. 15, 2017

(51) Int. Cl. B64C 3/18; B64F 5/10

(52) U.S. Cl. CPC B64C 3/187; B64F 5/10; B64C 3/185

(57) ABSTRACT

An aircraft wing construction assembly that includes a rib with an integral first spar post and a second spar post that is separate from the rib and is attachable to the rib by fasteners.

### FIELD

This disclosure pertains to an aircraft wing construction assembly. More specifically, this disclosure pertains to an aircraft wing construction assembly that includes a rib with an integral first spar post and a second spar post that is separate from the rib and is attachable to the rib by fasteners.

### BACKGROUND

FIG. 1 is a representation of a conventional rib configuration 12 in an aircraft wing construction. The rib configuration 12 is basically constructed of three separate metal components, a rib 14, a first rib post 16 and a second rib post 18.

The rib 14 has a longitudinal length that extends between a first end 22 of the rib and an opposite second end 24 of the rib. The longitudinal length of the rib 14 extends across the width of an aircraft wing construction between a front spar of the aircraft wing construction and a rear spar of the aircraft wing construction.

The first rib post 16 is attached to the first end 22 of the rib 14 by a plurality of fastener assemblies 26. The fastener assemblies 26 are typically metal bolt and nut type fastener assemblies, or other equivalent fastener assemblies. The first rib post 16 is attached to a first spar (not shown) of an aircraft wing construction by additional fastener assemblies (not shown).

The second rib post 18 is attached to the second end 24 of the rib 14 by further fastener assemblies 28. Again, the fastener assemblies 28 are typically metal bolt and nut type fastener assemblies, or other equivalent fastener assemblies. Still further fastener assemblies (not shown) attach the second rib post 18 to a second spar (not shown) of the aircraft wing construction.

The number of fasteners needed to attach the first rib post 16 to the first end 22 of the rib 14 and to attach the second rib post 18 to the second end 24 of the rib 14 significantly contribute to the expense of the three component rib configuration represented in FIG. 1.

Additionally, the use of fasteners to attach the first rib post 16 to the first end 22 of the rib 14 and to attach the second rib post 18 to the second end 24 of the rib 14 requires stress analysis of the joint to be performed at the locations of the fasteners. The number of the fasteners makes such an analysis difficult.

Furthermore, the need to drill holes for all the fasteners through the opposite ends of the rib 14 and through the first rib post 16 and the second rib post 18 and then to install all of the fasteners through the drilled holes significantly contributes to the time required to construct the three component rib configuration represented in FIG. 1.

### SUMMARY

The aircraft wing construction of this disclosure saves weight, reduces part count and saves fasteners. It also saves in the cost of the installation of a rib in the final assembly of the aircraft wing construction. Additionally, there is no need for a joint stress analysis at one end of the rib. The aircraft wing construction assembly also enables a faster assembly of a rib to the aircraft wing.

The aircraft wing construction assembly includes a rib that is constructed of metal. The rib has a vertical height that extends between a top edge of the rib and a bottom edge of the rib. The rib also has a longitudinal length that extends between a first end of the rib and a second end of the rib, and a lateral width.

A first spar post is integrally constructed as one piece with the rib at the first end of the rib. With the first spar post being integrally constructed with the rib, there is no need for fasteners to attach the first spar post to the rib. The weight of the fasteners and the time required to connect the first spar post to the first end of the rib are eliminated. The excess material that is required to maintain edge distance (typically, a width equal to twice the diameter of the fastener) from the fastener centerline to the end of the parts is also eliminated as a result of eliminating the rib to ribpost joint. The first spar post has a longitudinal portion that extends longitudinally from the first end of the rib. The first spar post also has a lateral portion that extends laterally from the opposite side of the longitudinal portion of the first spar post from the first end of the rib. The lateral portion of the first spar post is configured to be attached to a first spar of the aircraft wing construction by fasteners that extend through the lateral portion of the first spar post and through the first spar.

The aircraft wing construction assembly also includes a second spar post constructed of metal. The second spar post is a separate construction from the rib. The second spar post has a longitudinal portion that is configured to be attached to the second end of the rib by fasteners. The fasteners extend through the longitudinal portion of the second spar post and through the second end of the rib in attaching the second spar post to the second end of the rib. The second spar post also has a lateral portion that extends laterally from the longitudinal portion of the second spar post. The lateral portion of the second spar post is configured to be attached to a second spar of the aircraft wing construction by fasteners inserted through the lateral portion of the second spar post and through the second spar.

The features, functions and advantages that have been discussed can be achieved independently in various embodiments or may be combined in yet other embodiments, further details of which can be seen with reference to the following description and drawings.

### BRIEF DESCRIPTION OF THE DRAWINGS

FIG. 1 is a representation of a side elevation view of a conventional, three component rib configuration.

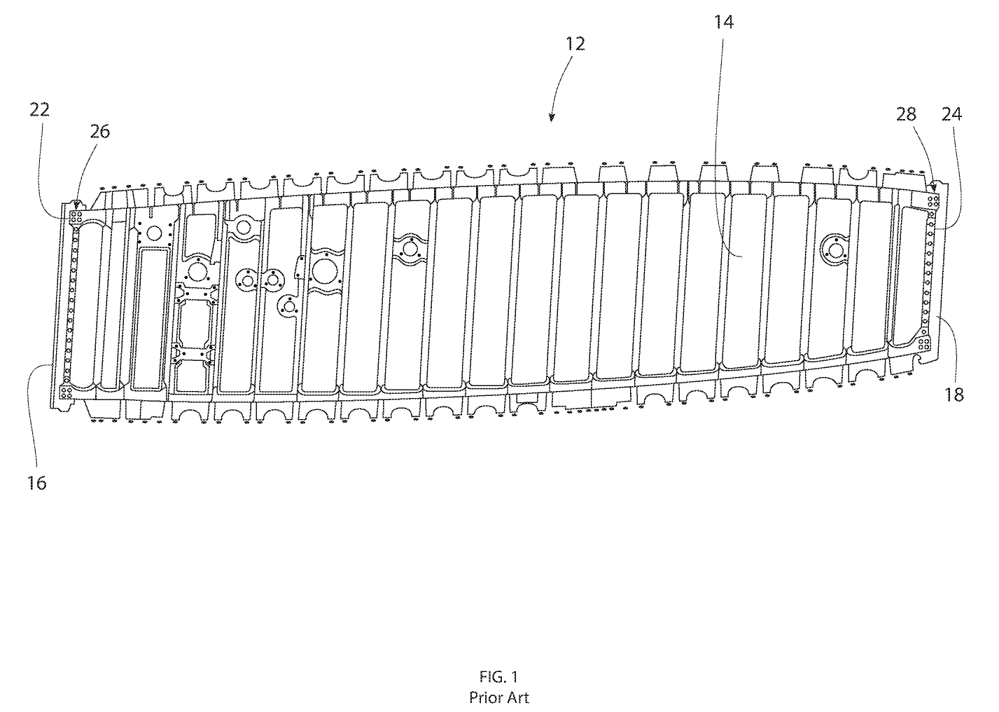

FIG. 2 is an enlarged partial view of a first end of the three component rib construction represented in FIG. 1.

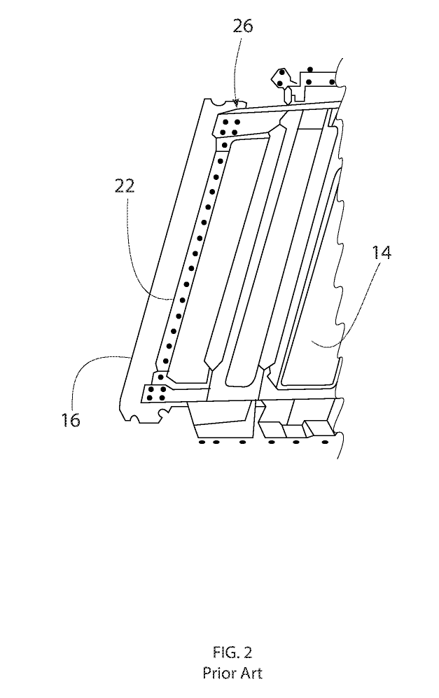

FIG. 3 is an enlarged partial view of a second end of the three component rib configuration represented in FIG. 1.

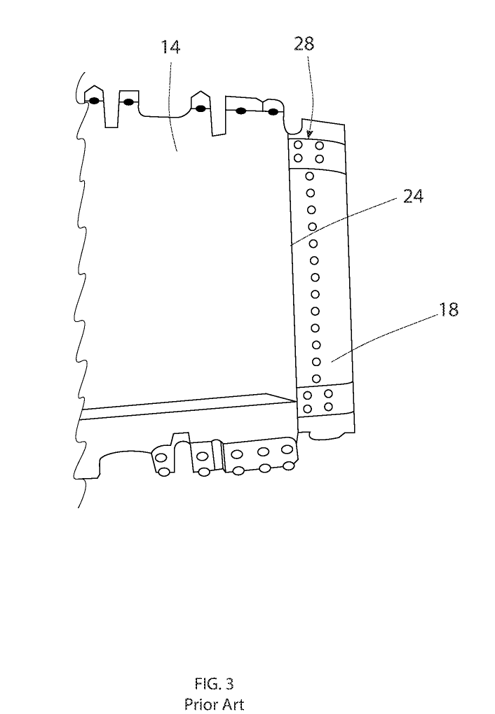

FIG. 4 is a representation of a side elevation view of the aircraft wing construction assembly of this disclosure.

FIG. 5 is an enlarged partial view of the first end of the aircraft wing construction assembly represented in FIG. 4.

FIG. 6 is an enlarged partial view of the opposite side of the first end of the aircraft wing construction assembly represented in FIG. 5.

FIG. 7 is an enlarged partial view of the second end of the aircraft wing construction assembly represented in FIG. 4.

FIG. 8 is an enlarged partial view of the opposite side of the second end of the aircraft wing construction assembly represented in FIG. 7.

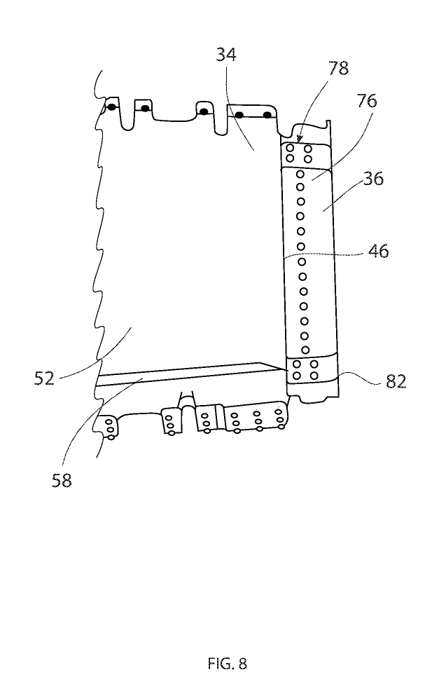

FIG. 9 is an enlarged partial view of the first end of the aircraft wing construction assembly represented in FIG. 4 along the line 9-9.

### DETAILED DESCRIPTION

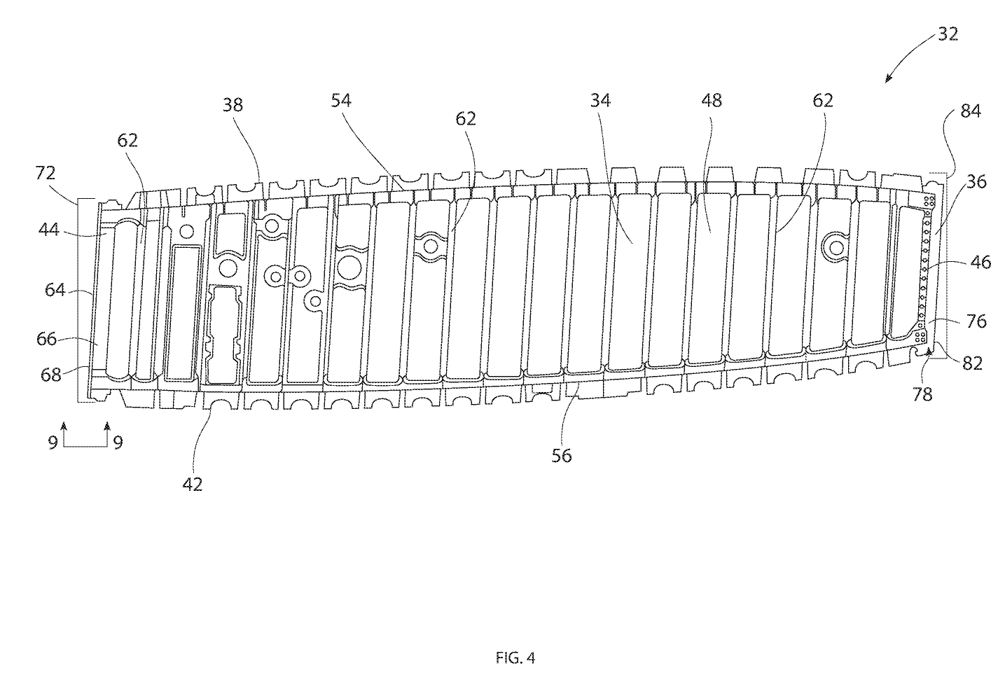

The aircraft wing construction assembly 32 is comprised of a two component rib configuration represented in FIG. 4. By being only a two component rib configuration, the aircraft wing construction assembly 32 reduces the part count for the assembly, reduces the weight of the assembly, reduces the fasteners required for assembly, reduces the cost of final assembly and reduces the time of final assembly.

The aircraft wing construction assembly 32 is basically comprised of a rib 34 and a separate spar post 36. Both the rib 34 and the spar post 36 are constructed of metal. However, other equivalent materials could be used in the construction of the rib 34 and the separate spar post 36.

The rib 34 has a vertical height that extends between a top edge 38 of the rib and a bottom edge 42 of the rib. The rib 34 also has a longitudinal length that extends between a first end 44 of the rib and a second end 46 of the rib. The rib 34 also has a lateral width between a first side surface 48 of the rib and a second side surface 52 of the rib. The rib 34 is constructed with flanges 54, 56 that project laterally outwardly from the first side surface 48 of the rib. The flanges 54, 56 extend along the length of the rib from the first end 44 of the rib 34 to the second end 46 of the rib 34. An additional flange 58 projects laterally outwardly from the second side surface 52 of the rib. The additional flange 58 extends along the longitudinal length of the rib 34 from the first end 44 of the rib 34 to the second end 46 of the rib. The flanges 52, 54, 56 all reinforce the length of the rib 34.

The rib 34 is also stiffened with a multitude of webs 62 that project laterally outwardly from the first side surface 48 of the rib 34. Each of the webs 62 extend across the first side surface 48 of the rib 34 and intersect with the first flange 54 at the top of the rib 34 and the second flange 56 at the bottom of the rib. The webs 62 also reinforce the construction of the rib 34.

A first spar post 64 is integrally machined with the rib 34 at the first end 44 of the rib. The first spar post 64 extends across the vertical height of the rib 34 between the top edge 38 of the rib 34 and the bottom edge 42 of the rib 34. The first spar post 64 has a generally planar, longitudinal portion 66 that extends longitudinally or projects longitudinally from the first end 44 of the rib 34. The longitudinal portion 66 of the first spar post 64 also extends along the first end 44 of the rib 34 between the top edge 38 of the rib and the bottom edge 42 of the rib. The first spar post 64 also has a lateral portion 68 that extends laterally from the longitudinal portion 66 of the first spar post 64.

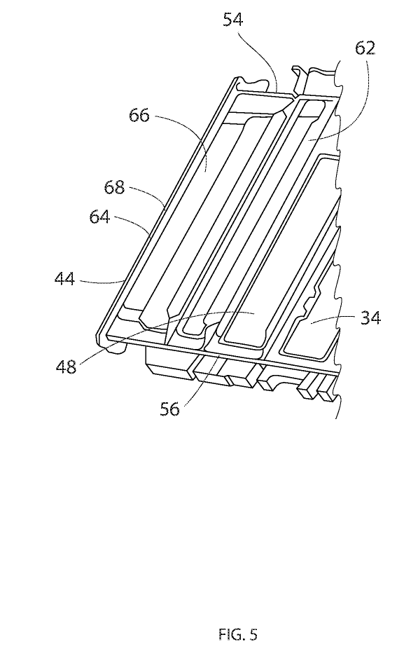

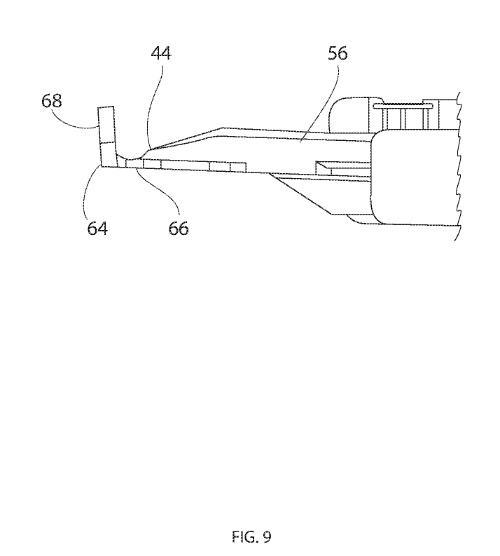

The lateral portion 68 of the first spar post 64 extends along substantially all of the vertical height of the longitudinal portion 66 of the first spar post 64. As can be seen in FIGS. 5, 6 and 9, the lateral portion 68 of the first spar post 64 and the longitudinal portion 66 of the first spar post 64 have an angular cross-section configuration. The lateral portion 68 of the first spar post 64 is configured to be attached to a first spar 72 (represented schematically in FIG. 4) of an aircraft wing construction by fasteners that extend through the lateral portion 68 of the first spar post 64 and through the first spar 72, attaching the rib 34 to the first spar 72.

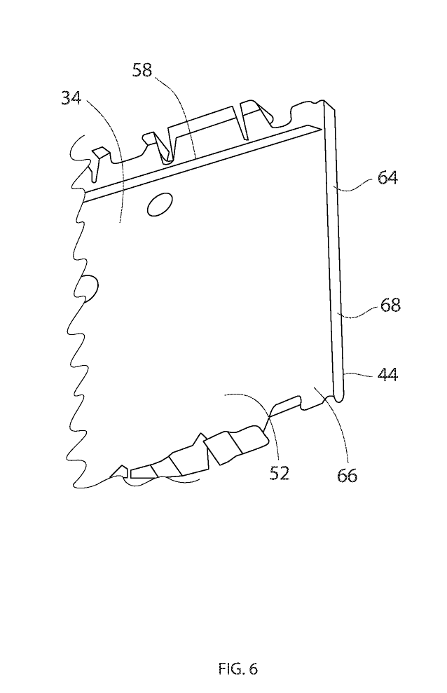

As can be seen in FIGS. 5 and 6, the flanges 54, 56, 58 extend longitudinally across the longitudinal portion 66 of the first spar post 64 to the lateral portion 68 of the first spar post.

The rib 34 with the integral first spar post 64 is only one rib and integral first spar post of a plurality of like ribs and first spar posts that go into the aircraft wing construction with each rib of the plurality of like ribs having an integral first spar post.

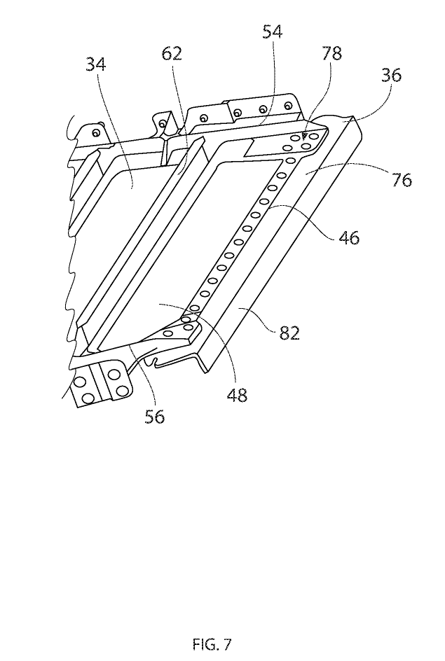

The aircraft wing construction assembly 32 also includes a second spar post 36 constructed of metal or other equivalent material. The second spar post 36 is a separate construction from the rib 34. The second spar post 36, like the first spar post 64 has a generally planar longitudinal portion 76. The longitudinal portion 76 of the second spar post 36 is configured to be attached to the second end 46 of the rib 34 by fasteners 78. The fasteners 78 extend through the longitudinal portion 76 of the second spar post 36 and through the second end 46 of the rib 34. With the longitudinal portion 76 attached to the second end 46 of the rib 34, the longitudinal portion 76 extends or projects longitudinally from the second end 46 of the rib 34. The longitudinal portion 76 of the second spar post 36 when attached to the second end 46 of the rib 34 extends substantially across all of the vertical height of the second end 46 of the rib 34. The second spar post 36 also has a lateral portion 82 that extends laterally from the longitudinal portion 76 of the second spar post 36. As represented in FIG. 7, the lateral portion 82 of the second spar post 36 and the longitudinal portion 76 of the second spar post have an angular cross-section configuration. The lateral portion 82 of the second spar post 36 is configured to be attached to a second spar 84 of the aircraft wing construction (represented schematically in FIG. 4) by fasteners that extend through the lateral portion 82 of the second spar post 36 and through the second spar 84.

The method of constructing the aircraft wing construction assembly 32 involves first attaching the second spar post 36 that is separate from the rib 34 to the second spar 84 of the aircraft wing. Alternatively, the first spar post 64 that is integrally formed with the rib 34 could be attached to a first spar 72 of the aircraft wing. In either order of assembly, the second spar post 36 is attached to the second spar 84 with fasteners that extend through the lateral portion 82 of the second spar post 36 and through the second spar 84. The first spar post 64 is attached to the first spar 72 by fasteners that extend through the lateral portion 68 of the first spar post 64 and through the first spar 72. The second end 46 of the rib 34 is then attached to the second spar post 36 by fasteners inserted through the second end 46 of the rib 34 and through the longitudinal portion 76 of the second spar post 36. This attaches the rib 34 extending between the first spar 72 and the second spar 84. The second spar post 36 being separate from the rib 34 enables adjustably positioning the second spar post 36 and the rib 34 to take up manufacturing tolerance.

As various modifications could be made in the aircraft wing construction assembly 32 herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

1. An aircraft wing construction assembly comprising:
a rib having a length that extends between a first end of the rib and a second end of the rib;
a first spar post at the first end of the rib, the first spar post is integrally formed as one piece with the rib, the first spar post is configured to be attached to a first spar of the aircraft wing construction; and,
a second spar post that is separate from the rib, the second spar post is attached to the second end of the rib, the second spar post is configured to be attached to a second spar of the aircraft wing construction.

2. The aircraft wing construction assembly of claim 1, further comprising:
the second spar post is attached to the second end of the rib by fasteners.

3. The aircraft wing construction assembly of claim 1, further comprising:
the rib is one of a plurality of like ribs, each rib of the plurality of like ribs having a first spar post formed integrally as one piece with the rib.

4. The aircraft wing construction assembly of claim 3, further comprising:
the second spar post is one of a plurality of second spar posts, each second spar post of the plurality of second spar posts is attached to a second end of a rib of the plurality of like ribs.

5. The aircraft wing construction assembly of claim 1, further comprising:
the first end of the rib and the first spar post have an angular cross-section configuration.

6. The aircraft wing construction assembly of claim 1, further comprising:
the first spar post and the rib are integrally formed as one piece of metal.

7. The aircraft wing construction assembly of claim 1, further comprising:
a flange formed integrally on a side of the rib, the flange extending along the length of the rib to the first spar post.

8. The aircraft wing construction assembly of claim 7, further comprising:
a web formed integrally on the side of the rib, the web projecting from the side of the rib and intersecting the flange.

9. The aircraft wing construction assembly of claim 1, further comprising:
a first spar attached to the first spar post; and,
a second spar attached to the second spar post.

10. An aircraft wing construction assembly comprising:
a rib, the rib having a height that extends vertically between a top edge of the rib and a bottom edge of the rib, the rib having a length that extends longitudinally between a first end of the rib and a second end of the rib, and the rib having a width that extends laterally between a first side of the rib and a second side of the rib;
a first spar post, the first spar post being integrally constructed as one piece with the rib on the first end of the rib, the first spar post having a longitudinal portion that extends longitudinally from the first end of the rib and the first spar post having a lateral portion that extends laterally from the longitudinal portion of the first spar post, the lateral portion of the first spar post being configured to be attached to a first spar of an aircraft wing construction by fasteners that extend through the lateral portion of the first spar post and through the first spar;
a second spar post, the second spar post being a separate construction from the rib, the second spar post having a longitudinal portion that is configured to be attached to the second end of the rib by fasteners that extend through the longitudinal portion of the second spar post and through the second end of the rib, the second spar post having a lateral portion that extends laterally from the longitudinal portion of the second spar post, the lateral portion of the second spar post being configured to be attached to a second spar of the aircraft wing construction by fasteners that extend through the lateral portion of the second spar post and through the second spar.

11. The aircraft wing construction assembly of claim 10, further comprising:
the rib is one of a plurality of like ribs, each rib of the plurality of like ribs having a first spar post formed integrally as one piece with the rib.

12. The aircraft wing construction assembly of claim 11, further comprising:
the second spar post is one of a plurality of second spar posts, each second spar post of the plurality of second spar posts is attached to a second end of a rib of the plurality of like ribs.

13. The aircraft wing construction assembly of claim 10, further comprising:
the first spar post and the rib are integrally formed as one piece of metal.

14. The aircraft wing construction assembly of claim 10, further comprising:
a flange formed integrally on a side of the rib, the flange extending along the length of the rib and onto the longitudinal portion of the first spar post.

15. The aircraft wing construction assembly of claim 14, further comprising:
a web formed integrally with the rib, the web projecting from the side of the rib and intersecting the flange.

16. The aircraft wing construction assembly of claim 10, further comprising:
a first spar attached to the first spar post; and,
a second spar attached to the second spar post.

17. A method of constructing and aircraft wing, the method comprising:
attaching a first spar post that is integrally formed with a first end of a rib of the aircraft wing to a first spar of the aircraft wing;
attaching a second spar post that is separate from the rib to a second spar of the aircraft wing; and,
attaching a second end of the rib to the second spar post and therby attaching the rib to the first spar and to the second spar.

18. The method of claim 17, further comprising:
attaching the first spar post to the first spar and attaching the second spar post to the second spar with the rib extending between the first spar and the second spar.

19. The method of claim 17, further comprising:
attaching the second end of the rib to the second spar post with fasteners.

20. The method of claim 19, further comprising:
attaching the first spar post to the first spar with fasteners extending through the first spar post and through the first spar; and,
attaching the second spar post to the second spar with fasteners extending through the second spar post and through the second spar.
